(19) United States
(12) Patent Application Publication
(10) Pub. No.: US 2012/0143787 A1
(43) Pub. Date: Jun. 7, 2012

(54) SYSTEM AND METHOD FOR CREATING AND USING ENERGY CREDITS DERIVED FROM THE TRANSPORTATION INDUSTRY WHILE MAINTAINING GREEN CERTIFICATION

(76) Inventor: Aaron David Trent Needham, St. George, UT (US)

(21) Appl. No.: 13/334,789

(22) Filed: Dec. 22, 2011

Related U.S. Application Data
(63) Continuation-in-part of application No. 12/456,461, filed on Jun. 17, 2009.

(51) Int. Cl. G06Q 90/00

(52) U.S. Cl. 705/500

(57) ABSTRACT

A system and method for creating and using energy credits derived from the construction or transportation sectors while maintaining green certification. The system and method uses buildings or vehicles. The energy consumption of a building or vehicle is first reduced by identifying and placing predetermined components in the building or vehicle. That energy reduction is then designated as an energy credit derived from and associated with the construction sector or transportation sector. The credit is then marketed and sold. The remaining or residual energy consumption associated with use of the building or vehicle is then offset through the purchase of outside energy credits. The buildings or vehicles are then certified as green.

### RELATED APPLICATIONS

The present application is a continuation in part of U.S. patent application Ser. No. 12/456,461, filed Jun. 17, 2009 and entitled “SYSTEM AND METHOD FOR CREATING AND USING ENERGY CREDITS DERIVED FROM THE CONSTRUCTION INDUSTRY WHILE MAINTAINING GREEN CERTIFICATION”, the disclosure of which is incorporated by reference in its entirety.

### BACKGROUND OF THE INVENTION

1. The Field of the Invention

The field of the invention is the carbon cap and trade, renewable energy, and energy efficiency industries.

2. The Relevant Technology

Reduction of carbon emissions is increasingly at the forefront of discussion in private industry, government, and the general public. It is widely acknowledged that carbon emissions generated from various sources, including the production and consumption of energy in the construction, industrial, and transportation sectors, may contribute to global warming and climate change. Such effects may also result in economic loss across various industries.

According to various sources, residential and commercial buildings in the United States produce up to 39% of overall carbon emissions, making the construction sector, as defined by existing and planned buildings, a leading carbon emitter. Similarly, the transportation sector produces up to 33% of overall carbon emissions, making the transportation sector a leading carbon emitter. Together, the transportation and construction sectors account for as much as 72% of overall carbon emissions. Therefore, programs that target the carbon emissions of the construction and transportation sectors are critical to a focused effort to reduce overall carbon emissions.

Generally, there are several ways to reduce overall carbon emissions. There are also specific methods of reducing emissions which are unique to specific sectors (e.g., the construction sector or transportation sector, respectively). For example, at a general level, using energy more efficiently is one common way to minimize carbon emissions. Green building is a specific type of building practiced within the construction sector which uses building design to optimize energy efficiency of the building structure. In the United States, one nationally recognized program of green building is Leadership in Energy and Environmental Design (LEED). LEED certification is a specific green building certification that denotes that a building has met certain criteria for energy efficient design and that certain energy savings are being achieved. Criteria for LEED or other independent green certifications may include the use of renewable or recyclable energy, use of energy efficient products, or defining the carbon emissions of an entity and offsetting it through the purchase of energy credits.

As exemplified by its presence as LEED and other criteria, using energy generated from renewable sources is another important way to minimize carbon emissions. Renewable energy is energy generated from relatively unlimited natural resources such as solar, wind, geothermal, hydropower, and biomass.

Other mechanisms facilitating the reduction of carbon emissions are carbon cap and trade systems. These systems allow an entity to obtain, through purchase or trade, a carbon commodity or credit, which has been generated by the energy savings or renewable energy production of others, to “reduce” or “offset” the purchasing entity's carbon emissions. The producer who originally generated the credit may also receive a benefit from such systems and programs because he or she obtains a monetary or other return when his or her commodity is sold to a buyer.

One specific example of such a carbon credit represents energy savings generated and is called an Energy Efficiency Credit (EEC) or White Tag (collectively referred to herein as an “EEC”). This credit represents 1 megawatt-hour of electricity saved in an eligible manner. Certain states in the United States have developed and administer mandatory EEC programs for public utility entities. There are also voluntary markets for EECs whereby corporate and other private entities voluntarily reduce their carbon footprint by purchasing EECs.

Another example of a carbon credit represents energy generated directly from a renewable energy source and is called a Renewable Energy Credit (REC), Green Tag, or Tradable Renewable Certificate (TRC) (collectively referred to herein as an “REC”). This credit represents 1 megawatt-hour of electricity generated from an eligible renewable energy resource. The generator of an REC may trade or sell an REC after the generated electricity is fed into the electrical grid, and the purchaser of the credit generally receives a certificate stating that he has used renewable energy.

Significantly, there is currently no nationwide system of administering and accounting for RECs, and programs differ from state to state or region to region. More particularly, the value placed on RECs, as well as rules for their creation and trading, are a function of state-specific regulatory policies known as Renewable Portfolio Standards (RPSs).

To date, certain efforts have been made to target carbon emissions resulting from the construction sector by both individuals and government entities, including the Building America Team of the Department of Energy. Indeed these groups have sought to combine green building techniques to establish a unified program whereby building owners would effectively have no net utility bill expenses. However, to date, these attempts have not fully utilized the carbon credit concepts described above, and have also been unsuccessful in their stated ambitions of achieving net zero utility bills through a unified program targeting construction sector-based carbon emissions.

Therefore, a comprehensive program targeting carbon emissions in the construction sector by both generating carbon credits derived from and associated with the construction sector, and using green building to achieve net zero utility bills has been elusive to date. Notably, from the carbon credit side, the existing carbon credit systems are inadequate for this endeavor for several reasons.

First and foremost, none of the current carbon credit systems specifically target carbon emissions generated within the construction sector, a predominant carbon emitter. While, to some extent, government programs identify RECs for emissions generated in the utility sector, existing systems for RECs and EECs do not otherwise distinguish among sectors of industries generating carbon emissions, and they certainly do not target emissions generated by the construction sector. Specifically, RECs are identified only according to generating renewable resource type and the geographical location where they were generated. Therefore, those who produce, trade, or otherwise incentivize these credits cannot ascertain whether their efforts to reduce carbon emissions are precisely aimed at a leading source of carbon emissions, as opposed to a less significant source.

Second, a standardized system of valuing and trading RECs and EECs interstate does not exist due to the fact that each state's RPS, which defines and administers RECs and EECs, is unique and reflective of the policy objectives and self-interests of that particular state. Such policy objectives and self interests include favoritism to renewable resources particular to that state. More particularly, because renewable energy sources upon which RECs are based vary from state to state, there is no single and common renewable resource generating credits from each state and there is no conforming value between the credits for each state. Therefore, incorporating RECs across and between states is currently impractical.

For the foregoing reasons, a universal method of identifying and targeting carbon emissions produced from the construction sector by both generating a universally accepted energy credit within that sector and using green building and certification to achieve net zero utility bills is needed. Such a method could also be adapted for use in the transportation sector.

### BRIEF SUMMARY OF THE PREFFERED EMBODIMENTS

In accordance with the above, an innovative system and method is provided. The invention sets forth a system and method for creating and using energy credits from a vehicle, building, or in building construction, which credits are specifically derived from the transportation or construction industries. Through combining green building techniques with a new form of energy credit, entities are ultimately able to achieve net zero utility bills while maintaining green certification for buildings. Similarly, energy saving components may likewise be installed on a target vehicle, so as to reduce energy consumption of said vehicle, and allow the reduced energy consumption to support issuance and sale of an associated energy credit. With respect to placement or installation components configured to reduce energy consumption, the terms “place” and “install” are used interchangeably herein.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a flowchart describing in broad terms the overall and basic steps of the system and method claimed according to one embodiment of the present invention.

FIG. 2 is a flowchart describing in specific detail the step of reducing the energy consumption of a building or vehicle, according to one embodiment of the present invention, which is one of several steps of the present invention.

FIG. 3 is a flowchart describing in specific detail the step of quantifying energy reduction as an energy credit, according to one embodiment of the present invention, which is one of several steps of the present invention.

FIG. 4 is a flowchart describing in specific detail the steps of offsetting carbon emissions and certifying a building or vehicle as green, according to one embodiment of the present invention, which is one of several steps of the present invention.

### DETAILED DESCRIPTION OF THE PREFERRED EMBODIMENTS

The present invention in its various embodiments is a system and method for creating and using energy credits in a building, in building construction, or with respect to a vehicle, which credits are specifically derived from the construction or transportation industries, as well as maintaining green certification. More specifically, the system and method involves a process whereby the energy consumption of a vehicle, building or planned building is reduced, the reduction being quantified as an energy credit derived from the construction or transportation sectors, and then sold. The carbon emissions resulting from the residual energy consumption of the building or vehicle is then ascertained and offset through the purchase of outside energy credits, and the building or vehicle is certified as green.

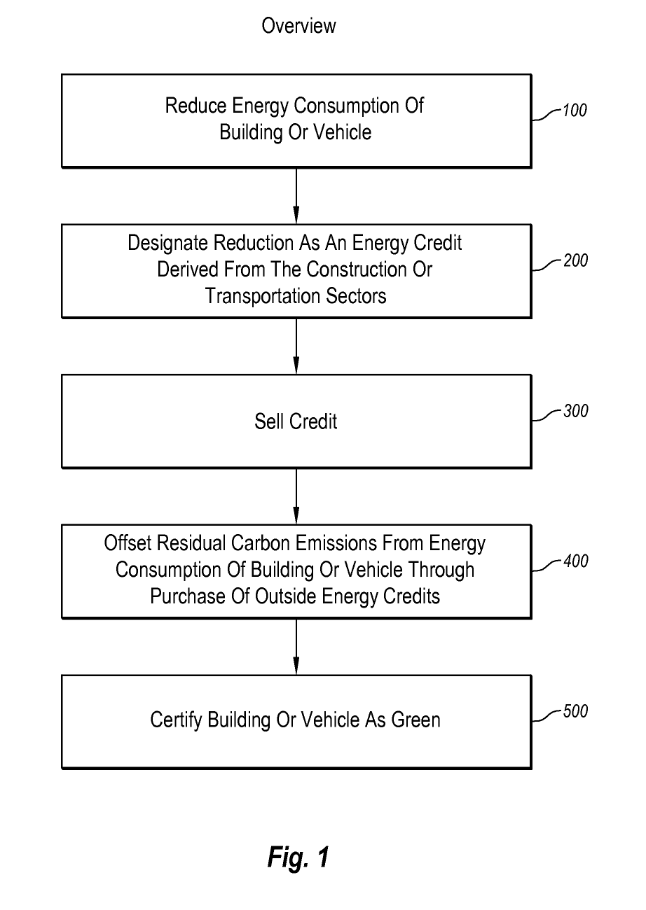

FIG. 1 is a flow chart that generally illustrates a system and method claimed by delineating the steps involved at a broad level. In one embodiment of the current invention, the steps take place as part of an overall program through which homeowners, builders, vehicle owners, vehicle manufacturers, or other entities elect to participate. The preferred embodiment may be largely administered as a comprehensive program by a private entity named HYBRIDENERGYHOMES or BLUETAGCREDITS. In the preferred embodiment, HYBRIDENERGYHOMES or BLUETAGCREDITS administers or oversees the implementation of the system and method for other entities as a paid service and in connection with the comprehensive program. However, any or all of the steps in the system and method may be performed by any entity in order to effectuate the system and method.

The method begins once it is determined that it is desirable for the energy consumption of or carbon emissions produced by a vehicle, building or planned building to be reduced. Steps are then taken to reduce the typical energy consumption of that vehicle or building by a certain predetermined amount [100].

The reduction of the energy consumption is designated as an energy credit specifically derived from the transportation or construction sector [200]. In the preferred embodiment, this credit may be specifically referred to as a BLUE TAG or BLUE TAG CREDIT (BTC).

This credit is then marketed and sold to other entities, including those who desire to offset their own existing carbon emission production [300].

Next, the remaining carbon emissions produced from the residual energy consumption associated with the building or vehicle are offset through the purchase of outside energy credits [400].

Finally, the building or vehicle, which now offsets 100% of its carbon emissions, is granted green certification [500].

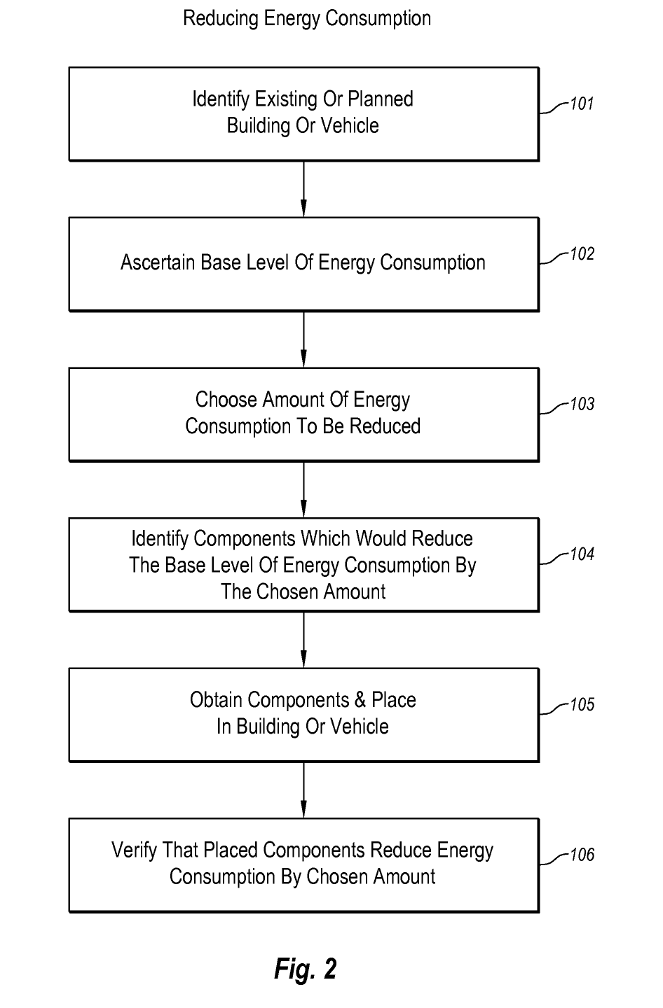

Reference to FIG. 2 is now made to begin to illustrate more specifically the steps of a claimed system and method according to one embodiment. More particularly, FIG. 2 breaks down into subparts the step of reducing the energy consumption of a building or vehicle. First, an existing or planned vehicle, building or buildings are identified [101]. All types of buildings or vehicles may be identified for participation within the system and method. Existing buildings or buildings at the conceptual or development stage may be identified. Commercial, residential, or any other building types may be included. Similarly, the identified vehicle may be an existing vehicle or a vehicle yet to be manufactured (e.g., a vehicle special ordered from the vehicle manufacturer). The identification of buildings for participation may be limited to single buildings or comprehend entire developments. Likewise, the identification of a vehicle may be a single vehicle or multiple vehicles (e.g., a fleet of vehicles maintained by any particular entity). No particular building type or vehicle is excluded under this step. Examples of contemplated vehicles that may be so identified include, but are not limited to automobiles, trucks, locomotives and trains (e.g., including any vehicle that travels on a railroad), watercraft, and aircraft. Such vehicles may be personal or commercial.

Once a vehicle, building or buildings are identified, a base level of energy consumption typically produced as a result of the normal use for the vehicle, building or buildings is ascertained [102]. For an existing building, this may be accomplished by any one of a number of means, including obtaining usage information from energy or utility bills, as well as by reference to other existing sources of energy usage information for the building. Similar means may be employed for an existing vehicle (e.g., looking at MPG mileage history, etc.).

In one embodiment of the invention, a base level of energy consumption is ascertained using one or more software products, such as ENERGY GAUGE, MICROPAS, and/or REM/RATE. Similar products specific to energy consumption of vehicles and the transportation industry could be used to determine a base level of energy consumption for one or more vehicles. By inputting certain building information such as: physical dimensions; applicable building codes; physical properties and components like foundation, exterior materials, insulation, windows and exterior doors; heating and cooling systems; and electrical loads into these software programs, a user may obtain detailed performance-based analysis of building energy, including the calculation of heating, cooling, hot water, lighting, and appliance energy loads for both planned and existing buildings. Accordingly, by using such software products or by referring to other sources, a base rate of energy usage for a building may be obtained, typically in kilowatt hours (KWh) or megawatt hours (MWh) over a given period (e.g., per month, per year, etc.).

A similar process may be employed for ascertaining a base level of energy consumption for a vehicle. For example, certain vehicle information such as its base level of energy consumption may be obtained through reference to the CAFE standard. The CAFE standard is the corporate average fuel economy that is regulated by the Environmental Protection Agency (EPA), National Auto Dealership Association (NADA), and National Highway and Traffic and Safety Association (NHTSA). This standard regulates the annual baseline of what a vehicle of any given model year and type can emit, as well as its efficiency (MPG). By using the CAFE standard to determine the baseline, emissions savings, and production of credits, a national standard is already available that addresses all twelve regulated gaseous emissions. The base rate of energy usage for the vehicle may thus be obtained and provided in appropriate units (e.g., KWh, MWh) over a given period (e.g., per month, per year, etc.) or over a given distance travelled (e.g., MPG). With respect to vehicles, one measurement of the base rate of energy usage (or at least its efficiency) may be provided in MPG. Of course, vehicles that do not use conventional fuels (e.g., an electric vehicle) may be measured in other appropriate measurements (e.g., KW/mile).

Once a base level of energy usage for a building or vehicle is ascertained, a specific amount or range of this energy usage or consumption is chosen to be reduced below the base level [103]. In the preferred embodiment, a comprehensive program implemented by HYBRIDENERGYHOMES or BLUETAGCREDITS, one may select between three possible ranges of energy reduction: (1) a Bronze option, whereby energy consumption will be reduced between 40% to 60% below the existing base level; (2) a Silver option, whereby energy consumption will be reduced between 60% to 75% below the existing base level; and (3) a Gold option, whereby energy consumption will be reduced between 75% to 90% below the existing base level. However, any number of ways may be utilized to quantify or select a reduction in energy consumption below the base level.

After a certain amount of energy usage or consumption is chosen to be reduced below the existing base level, various components are identified which, if utilized in the building or vehicle, would bring about the reduction of energy previously chosen [104]. A precise determination of the components required to bring about the desired energy consumption reduction may be assisted by the use of the ENERGY GAUGE, MICROPAS, and REM/RATE products mentioned above. These products assist one in the choice by recommending component options based upon existing conditions and desired energy level reductions. In the context of buildings, such components may include, but are not limited to: windows, doors, exterior wall coverings, roofing insulation, solar and wind applications, geothermal systems, exterior patios, landscaping, water features, insulation, HVAC systems, water heaters, appliances, outlets, light fixtures, window coverings or even the location and orientation of the building itself. Any number of additional components which would reduce the base level of energy consumption of a building or buildings if placed within the building or buildings may be identified.

In the context of a vehicle, such components may include, but are not limited to various energy efficient and/or renewable energy equipment that can be installed on the vehicle to increase energy efficiency and mileage. Examples of such components may include, but are not limited to, carburetors, computer systems for controlling energy usage, fuel injection systems, catalytic converters, braking systems, solar generating components, wind generating components, paint products, electric engine components, battery packs for powering an electric engine, exhaust systems, components for decreasing wind drag, and tires. Also, fuel additives, synthetic fuel products, and/or other replacement fuels can be used to increase the energy efficiency performance of a vehicle.

Importantly, for the purposes of the system and method, energy reduction may also include, and be further defined by, energy production from renewable resources. Illustrated in another way, overall energy reduction for a building or vehicle may be accomplished not only through energy efficiency per se, but also through solar, wind, geothermal, or other applications which reduce overall energy consumption in a building or vehicle below the base level through the production of renewable energy, which may be used in the building or vehicle.

After the components are identified, some combination or all of them are obtained, and placed in the building(s) or vehicle(s) [105]. For an existing building or vehicle, this component placement may effectively include a retrofit of the existing structure or vehicle by replacement of existing components with the new ones. Alternatively, component placement for an existing building or vehicle may simply involve the addition of components to the existing structure. For a planned building or vehicle, component placement may require components to be singularly or systematically added to the building or vehicle concurrent with building construction or vehicle manufacture. Similarly, some or all of the components may be placed in the building or vehicle at any time subsequent to building construction or vehicle manufacture. The timing of component placement may vary, according to the particular embodiment utilized, and is not critical to the invention as long as they assist to achieve the desired reduction in energy consumption.

Subsequent to component placement, one verifies that the placed and operating components actually reduce energy consumption below the base level in the range or specific amount previously selected [106]. Verification may be made in any number of ways as long as confirmation is made that the actual energy consumption being reduced by the placed or installed components is in harmony with the previously chosen consumption reduction. For example, in one embodiment of the method, verification may take place by reading on-site meter devices connected to the placed components. In another embodiment, verification may be made largely off-site from on-site meter devices connected to the placed components that transmit energy consumption information.

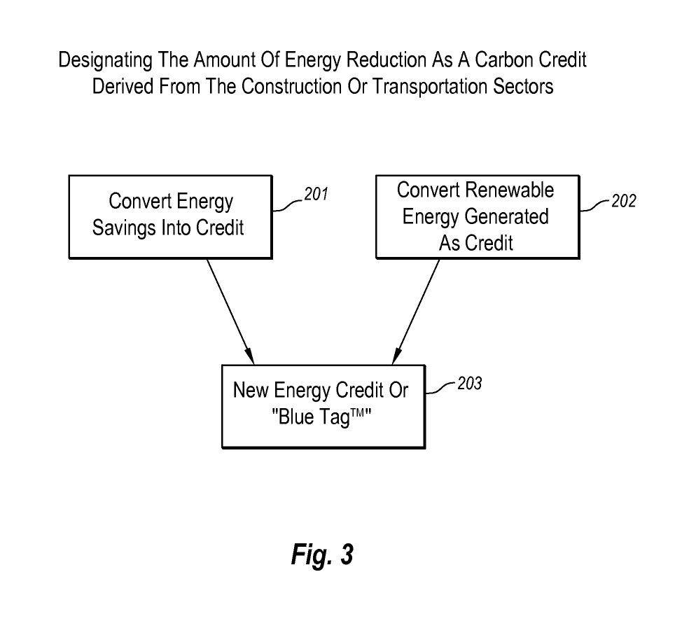

Reference to FIG. 3 is now made to further illustrate more specifically the steps of the claimed system and method. More particularly, FIG. 3 breaks down into subparts the step of designating the amount of energy reduction as a carbon credit derived from the construction sector or the transportation sector.

Designation of the amount of energy reduction as an energy credit derived specifically from the construction industry or transportation industry is a significant aspect of one embodiment of the present invention and also represents innovation in the field of carbon and energy credit systems. In the preferred embodiment, the energy credit is specifically designated as a BLUETAG [203]. Criteria for the generation of a BLUETAG energy credit specifically include energy savings specific to, and renewable energy generated within, the construction sector and/or transportation sector. A BLUETAG therefore incorporates some elements of existing systems of carbon credits in that: (1) energy savings from placed components are converted into a credit [201], akin to an Energy Efficiency Credit (EEC), and (2) renewable energy produced from placed components is also converted into a credit [202], akin to a Renewable Energy Credit (REC). However, because the BLUETAG may be derived exclusively from and identified with one of the construction or transportation sectors, it supercedes any relation to the EEC and REC systems by tying the carbon credit concept specifically and exclusively to carbon emissions generated within the construction sector or transportation sector. For example, the BLUETAG may be used within a standardized system of valuing and trading RECs interstate, which system is, in turn, based on a single, common resource-buildings or vehicles. Some embodiments may generate the energy credit from a combination of sectors (e.g., partially from the construction sector and partially from the transportation sector).

The precise conversion from energy reduction to energy credit is generally made by calculating the amount of MWh saved and designating the savings in MWh as an equal amount of energy credits produced. For example, if 10 MWh of energy is reduced, the savings results in 10 energy credits generated (i.e., in one embodiment, each BLUETAG credit is equivalent to 1 MWh energy reduction). Importantly, energy savings from such sources as gas may also be converted into an energy credit by first converting reductions in standard units of gas—such as British Thermal Units (BTUs)—to KWh or MWh (10,000 BTU=2.93 KWh), and finally to an equivalent amount of energy credits. While the precise name of the credit may vary according to different embodiments, important to an embodiment of the system and method claimed is that the designation of the credit denotes the credit's derivation from and association with a particular sector (e.g., the construction sector or transportation sector).

Referring back to FIG. 1, after the energy reduction is designated an energy credit, the credit may be marketed, sold or traded [300]. Ultimately, the proceeds from any such transaction may be returned or forwarded to the owner or other responsible party associated with the building or vehicle. This return may significantly offset the building or vehicle owner's initial costs of participating in the system and method by providing a mechanism to reduce the up-front costs that may be incurred due to placement or installation of components. Employing one or more cost-offsetting mechanisms may also effectively achieve net-zero utility bills for the building or vehicle owner because costs for any residual energy consumption related to the building or vehicle may be offset through the sale of energy credits.

Other cost-offsetting mechanisms may be employed in connection with the system and method, including local, state, or federal tax credits and energy efficiency mortgages. Because of increasing demand and policy incentives for energy efficiency, these and other cost-offsetting mechanisms are in a state of rapid development and flux. Therefore, cost-offsetting is not limited to the mechanisms specifically described herein.

Finally, green certification of buildings or vehicles is integral to one embodiment of the overall method described herein, and may often be pre-requisite to demonstrating qualification for and obtaining of the cost-offsetting mechanisms described above. Under the system and method described, criteria for green certification include the offset of 100% of carbon emissions produced from energy consumption related to normal use of the building or vehicle. In the preferred embodiment of the system and method, green certification is reviewed and issued by HYBRIDENERGYHOMES or BLUETAGCREDITS, a business located in St. George, Utah. In order to achieve green certification, several steps are taken.

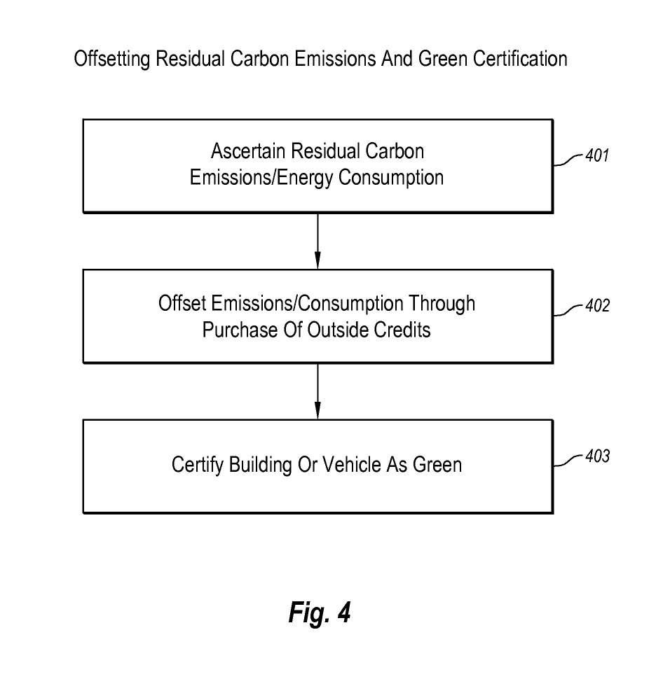

Reference to FIG. 4 is now made to further illustrate more specifically the steps of the claimed system and method. More particularly, FIG. 4 breaks down into subparts the steps of offsetting carbon emissions and certifying the building or vehicle as green, according to one embodiment of the present invention, which is one of several steps of the present invention.

First, the direct and indirect carbon emissions generated from the normal operation of building(s) or vehicle(s) must be ascertained [401]. This may be accomplished through a review of the residual energy usage of the building or vehicle via utility bills, vehicle fuel bills, MPG history, or other bills or data associated with the building or vehicle or via use of the software or similar products described above. In the preferred embodiment, these residual emissions represent the remaining emissions which exist from the energy consumption of the building or vehicle after considerable energy consumption reduction measures have taken place. Accordingly, in the preferred embodiment, the remaining energy usage and, therefore, carbon emissions, will be minimal.

Once the direct and indirect carbon emissions generated from normal operation of the building or vehicle are ascertained, energy credits may then be purchased to offset these emissions [402]. More precisely, the amount of carbon credits required for offset is proportional to each ton of CO₂ emitted. In this example of the preferred embodiment, one ton of CO₂ is the equivalent of one carbon credit. It is noted that such a carbon credit is different from the BLUETAG credits described above (e.g., one BLUETAG credit equals 1 MWh of energy conserved, while 1 carbon credit may equal one ton of CO₂ emissions abated). Once these energy credits are purchased, the building is certified as green. In the preferred embodiment, this is done by HYBRIDENERGYHOMES or BLUETAGCREDITS certification.

The invention ultimately results in a system and method for a building, building construction, or vehicle whereby energy credits specifically derived from the construction industry or transportation industry are created and sold. Through combining green building or manufacturing techniques with this new form of energy credit, entities are able to achieve net zero utility bills while maintaining green certification in a manner which cannot be achieved by current carbon credit systems.

### BLUE TAG CREDITS Distribution

BLUETAG CREDITS uses an emission neutral definition to offset emissions to maintain Green certification. The emission foot print definition is used to define a specific level of a specific emission and offsetting that with the matching number of energy credits to the amount of emissions by tonnage.

The BTC emission neutral definition looks at the financial cost of achieving the goal of desired reduction in energy use or emissions by breaking down the amount of emissions into smaller weight amounts that reduces the amount of credits needed to offset those emissions. The goal is to find a financial application of achieving BTC neutral certification by using advertising dollars within a specific industry. The percentage of advertising dollars is estimated and evaluated every year by national accounting firms that evaluate the national average of what companies are spending on advertising to market their product.

For a manufacturer to certify his product as a BTC emission neutral product, the product must first be determined to save energy according to a given standard (e.g., the ENERGY STAR program) or that it produces renewable energy (e.g., as defined by the Califormia Energy Commission (CEC)).

Once the product qualifies to use the BTC logo according to ENERGY STAR or CEC, we use a national accounting firm's statistical averages of advertising expenses to offset a specific amount of emissions. For example:

CARBON FOOT PRINT:

Electricity generation produces emissions. Those emissions are added up to a total production on an annual basis per ton. For every ton of emissions produced, one energy credit is used to offset those emissions.

BTC CARBON NEUTRAL

1. Product is qualified by ENERGY STAR standards or similar that it saves energy or produces renewable energy by the CEC or similar.

2. The national accounting firm gives us the budget amount used by the different industries to promote their product.

3. We identify a specific dollar amount that will be used by the manufacturer to brand their product.

For example:

$$$$=energy credit (kwh)−emissions (lbs)=BTC neutral product

$300.00 one BTC 1000 kwh−CO₂ emissions 2000 lbs=BTC neutral

$150.00 ½BTC 500kwh−CO₂ emissions 1000 lbs=BTC neutral

$100.00 ⅓BTC 333kwh−CO₂ emissions 667 lbs=BTC neutral

$3.00 1/100BTC 10 kwh−CO₂ emissions 20 lbs=BTC neutral

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for creating and using energy credits, said credits being derived from the transportation industry, while also maintaining green certification, comprising the steps of:
identifying a vehicle;
ascertaining a base level of energy consumption for normal use of said vehicle;
choosing to reduce said base level of energy consumption by a certain amount;
identifying one or more components, which, if installed on said vehicle, would reduce said base level of energy consumption of said vehicle by said certain amount;
obtaining said components;
installing said components on said vehicle;
verifying that said installed components reduce said energy consumption of said vehicle by said certain amount;
designating said certain amount as an energy credit;
ascertaining direct and indirect carbon emissions generated from normal operation of said vehicle with said components installed;
purchasing energy credits to offset said direct and indirect carbon emissions generated from said vehicle; and
certifying said vehicle as green.

2. The method of claim 1 further comprising the step of marketing said energy credit to potential purchasers of the energy credit.

3. The method of claim 1 further comprising the step of exchanging said energy credit for a monetary value.

4. The method of claim 1 wherein the step of identifying a vehicle comprises identifying a vehicle selected from the group consisting of automobiles, trucks, locomotives, trains, watercraft, and aircraft.

5. The method of claim 1 wherein the step of identifying a vehicle comprises identifying an automobile.

6. The method of claim 1 wherein the steps of identifying, obtaining, and installing components comprises identifying, obtaining, and installing components selected from the group consisting of carburetors, computer systems for controlling energy usage, fuel injection systems, catalytic converters, braking systems, solar generating components, wind generating components, paint products, electric engine components, battery packs for powering an electric engine, exhaust systems, components for decreasing wind drag, and tires.

7. The method of claim 6 wherein the step of verifying comprises on-site inspection of the performance of said components.

8. The method of claim 7 wherein on-site inspection is conducted by reading monitoring devices connected to said components.

9. The method of claim 1 wherein the step of verifying comprises off-site inspection of the performance of said components.

10. The method of claim 9 wherein off-site inspection is conducted by collecting data from transmitting monitoring devices which are connected to said components on-site.

11. The method of claim 1 wherein the steps of the method are performed directly as a service by a single business entity.

12. The method of claim 1 wherein the steps of the method are performed indirectly as a service by a single business entity.

13. The method of claim 1 wherein the steps of identifying, obtaining, and installing components comprises identifying, obtaining, and installing components selected from the group consisting of fuel additives, synthetic fuel products, and/or other replacement fuels can be used to increase the energy efficiency performance of a vehicle.
